(19) United States
(12) Patent Application Publication
(10) Pub. No.: US 2018/0185118 A1
(43) Pub. Date: Jul. 5, 2018

(54) METHOD FOR PRODUCING A DENTAL RESTORATION STRUCTURE TO BE INDIVIDUALLY MANUFACTURED

(71) Applicant: COLTÈNE/WHALEDENT AG, Altstaetten (CH)

(72) Inventors: Simon SUTTER, Chur (CH); Werner BARTH, Elgg (CH); Martin SCHAUFELBERGER, Weesen (CH)

(21) Appl. No.: 15/740,269

(22) PCT Filed: Jul. 1, 2016
(86) PCT No.: PCT/EP2016/065485

§ 371 Date: Dec. 27, 2017

(30) Foreign Application Priority Data
Jul. 2, 2015 (EP) 15175065.0

(51) Int. Cl. A61C 5/77; A61C 5/73; A61C 9/00; A61C 13/00; B33Y 80/00; B33Y 10/00; B33Y 30/00

(52) U.S. Cl. CPC A61C 5/77; A61C 5/73; A61C 9/004; B33Y 30/00; B33Y 80/00; B33Y 10/00; A61C 13/0019

(57) ABSTRACT

A method for producing a dental restoration structure (1) that is to be individually manufactured by 3D printing. The method includes the following steps: i.) placing a substructure (2) in a 3D printer (3), in particular on a support plate (4); ii.) determining at least one of the form and/or the position of the substructure (2) in the 3D printer (3); iii.) comparing the determined form and/or position of the substructure (2) with 3D data of the dental restoration structure (1) to be individually manufactured; optional applying a connecting layer to the substructure (2) and/or conditioning the substructure (2); and iv.) applying material, in particular application of a composite material, on the substructure (2) in a 3D printing method such that the dental restoration structure (1) that is to be individually manufactured is obtained.

This application is a national stage completion of PCT/EP2016/065485 filed Jul. 1, 2016 which claims priority from European Application Serial No. 15175065.0 filed Jul. 2, 2015.

### FIELD OF THE INVENTION

The present invention relates to a method for producing a dental restoration structure to be individually manufactured, the use of a 3-D printer in such a method, a 3-D printer, and a method for adjusting a 3-D printer, according to the preambles of the independent claims.

### BACKGROUND OF THE INVENTION

Dental restoration structures, such as inlays, onlays, bridges, crowns or prostheses, generally comprise complex moldings. During the production thereof, the physical configuration of remaining tooth parts, adjacent and/or antagonistic teeth, and those of the affected jaw have to be taken into account individually. In addition, the original form of the teeth to be restored completely or partly and aesthetic aspects must not be disregarded. In order to produce such restoration structures, predominantly multi-stage molding and casting methods are used nowadays. Although these methods have been tried and tested in practice, they are associated with a high outlay on manufacture. Accordingly, in recent times a series of methods have been developed in order to reduce said outlay and to provide high-quality restoration structures in the dental sector.

A principal focus has been directed to so-called digital fabrication, in which three-dimensional objects are produced on the basis of computer-generated data. In this connection, firstly subtractive manufacturing methods have been disclosed, in which a desired molding is manufactured by data-controlled milling from solid material. However, this necessarily leads to considerable expenditure on material. In addition, the waste that accumulates must subsequently be disposed of or reconditioned in a complicated way.

However, additive manufacturing methods have also been developed, in which a molding is built up from one or more basic materials. In this connection, so-called 3-D printing occupies a special position. 3-D printers have the advantage that they use only as much material as is actually needed. This offers a considerable advantage, in particular during the production of molded parts in small numbers, such as is the general case in the manufacture of dental restoration structures.

For example, EP 1 021 997 A1 describes the use of a laser sintering method for producing tooth restorations, in which moldings are built up layer by layer from a sinterable powder.

EP 1 243 231 A2 discloses a method for producing dental restoration structures from plastic, in which an underlayer is provided and the initial material for the plastic structure is applied to the latter layer by layer via a computer-controlled application device. Following the output of a layer, the latter is hardened before the application of the next layer is carried out. The starting materials used are in particular highly viscous composite materials which, following the application, can be polymerized, for example by high-energy radiation such as light.

Known methods for producing dental restoration structures by 3-D printing are generally associated with considerable outlay. In particular, 3-D printers used for this purpose have to be laboriously adjusted before the actual manufacture of the desired shaped piece. In addition, from case to case, the position and geometry of a substructure to be printed must be read into a data processing unit used for the purpose, before the 3-D printing. If the basic values do not agree exactly with the real conditions, it is possible for deficient manufacture of the desired shaped piece or, in the worst case, even to cause damage of the 3-D printer. Because of the low printing speed, the manufacture of dental restoration structures by 3-D printing is, moreover, associated with a significant expenditure of time, which is not least reflected in the costs for a shaped piece produced in this way.

### SUMMARY OF THE INVENTION

The object of the invention is, therefore, to overcome the disadvantages of the prior art.

In particular, it is an object of the present invention to devise improved methods and devices for producing dental restoration structures to be individually manufactured by 3-D printing.

These objects are achieved by methods as recited in the claims, 3-D printers as recited in the claims, and by the use of a 3-D printer as recited in the claims.

A method according to the invention for producing a dental restoration structure to be individually manufactured by 3-D printing comprises the following steps:

i. placing a substructure in a 3-D printer, in particular on a support plate;

ii. determining the form and/or the position of the substructure in the 3-D printer by means of a scanner, in particular integrated in the 3-D printer;

iii. comparing the determined form and/or position of the substructure with 3-D data from the dental restoration structure to be individually manufactured;

iv. optionally: applying a connecting layer to the substructure and/or conditioning the substructure;

v. material application, in particular application of a composite material, to the substructure in a 3-D printing process in such a way that the dental restoration structure to be manufactured individually results.

By means of such a method, the production of a dental restoration structure to be manufactured individually by 3-D printing is considerably simplified. Data relating to the form of the substructure to be printed can be determined by the scanner immediately before the 3-D printing and read into the data processing unit. However, data, for example for various abutments, can also be stored in a database and loaded into the data processing unit. In this case, the exact positioning and alignment of the substructure in the 3-D printer can be omitted, since these parameters can be determined by the scanner.

The method according to the invention is therefore considerably more efficient than that described in the prior art. In addition, a series of fault sources, such as for example erroneous loading of the substructure to be printed into the 3-D printer or faults during the entry of the initial data, are avoided.

A further advantage of the method according to the invention is the possibility of producing dental restoration structures which are connected to the substructure with a form fit by undercuts. The 3-D printing of such restoration structures can be carried out in the 3-D printer, for example by means of multi-axially rotatable mounting of the substructure, in particular on a multi-axially rotatable support plate. Dental restoration structures produced by conventional methods are as a rule pushed onto the substructure and adhesively bonded. For this purpose, the substructure must be formed conically, for example, in order to permit the dental restoration structure to be slipped over. The omission of the conicity requirement ensures additional freedom in the configuration of dental restoration structures.

The possible applications of the method described are multifarious. For example, the substructure can be selected from a group comprising dental scaffolding structures, in particular from substructures for bridges or bars, abutments for implants or secondary parts; metallic or ceramic workpieces; or dental structures with ceramic, in particular milled or cast, crowns.

A tooth crown to be individually manufactured can, for example, be “printed” directly onto an abutment suitable for the present case.

A further area of application, which is opened up by the method according to the invention, is the production of dental restoration structures to be individually manufactured from semi-finished blanks. Thus, prefabricated metallic or ceramic workpieces can be inserted into the 3-D printer as a substructure and the dental restoration structure to be individually manufactured can be completed by “printing” the still lacking parts of the respective molding. A similar procedure is also possible in combination with ceramic crowns which, for example, are primarily manufactured by milling, or with metallic base structures for the manufacture of prostheses. As a result of the partial manufacture based on semi-finished blanks, dental restoration structures to be individually manufactured can be produced by 3-D printing with considerably lower expenditure on time and material.

The invention also relates to a method for adjusting a 3-D printer, in particular in an above-described method for producing a dental restoration structure to be individually manufactured. Said method comprises the steps:

i. Printing at least one structure by using a 3-D printing process;

ii. determining the form and/or the position of the at least one structure with a scanner, in particular integrated in the 3-D printer;

iii. comparing the form and/or the position of the structure with predefined parameters, in order to obtain comparative values;

iv. adapting the settings of the 3-D printer on the basis of the comparative values, if necessary;

v. optionally: carrying out steps i. to iv. again in order to monitor the adjustment.

The described adjustment method is applied in particular when 3-D printing highly viscous composite materials, such are used widely in the dental sector. The application of such materials for the 3-D printing requires a print head specifically designed for the purpose, for which reason the literature to some extent also mentions 3-D plotting. In the present connection, the terms 3-D printing and 3-D plotting are, however, used synonymously. When outputting such highly viscous composite materials by means of a 3-D printer, micro-droplets or micro-strands are produced within a layer to be printed. In the ideal case, these flow into one another before the material hardens, for example as a result of the action of light. This generally requires exact adaptation of the point or strand spacing and of the flow rate to the flow characteristics of the output material. The spacing of the micro-droplets and micro-strands, their size and thickness and also the flow rate can be set reliably by using a method according to the invention for adjusting a 3-D printer before the start of a respective printing operation.

In a method for producing a dental restoration structure that is to be individually manufactured or a method for adjusting a 3-D printer, as described above, the 3-D printing process can be monitored with the scanner, in particular integrated in the 3-D printer. As a result, in particular in the event of deviation of the print quality from predefined specifications, a first-time or renewed adjustment of the 3-D printer can be initiated. Should the workpiece to be manufactured have faults, these can if possible still be corrected during the printing operation. Should the correction of a fault not be possible, a printing operation that is still running can be terminated in the event of the detection of the fault, by which means a saving in time and materials is achieved.

In an above-described method for producing dental restoration structures to be individually manufactured by 3-D printing, the form of the dental restoration structure to be individually manufactured can be determined with the scanner, in particular integrated in the 3-D printer, and compared with the 3-D data from the dental restoration structure to be individually manufactured provided in step iii. Therefore, quality control of the manufactured shaped piece, in particular in relation to its surface quality or surface roughness, is achievable.

The invention also relates to a 3-D printer having an integrated scanner for capturing the form and/or the position of a substructure to be printed on and/or of a printed object.

In conjunction with the present invention, the function of the scanner can be based, for example, on the following principles:

direct physical contact

laser triangulation

laser time-of-flight

conoscopic holography

structured-light scanning

modulated-light scanning

stereoscopy

photometry

silhouette technology

industrial computer tomography (CT)

magnetic resonance imaging (MRI).

Such a 3-D printer can in particular comprise:
an in particular integrated scanner to capture the form and/or the position of a substructure to be printed on and/or of a printed object; and
a control unit, designed to carry out an above-described method for producing a dental restoration structure.

The control unit can be designed to carry out said method both in hardware terms and in software terms. It can be integrated completely in the 3-D printer or else arranged wholly or partly externally.

In a described 3-D printer, the in particular integrated scanner can be designed to determine the form and/or the position of a substructure to be printed on and/or of a printed object, in particular of a dental restoration structure.

In such a 3-D printer, the form and/or the position of a substructure that can be positioned in the 3-D printer can be captured with an in particular integrable scanner and be made available to a control unit for the structural creation of an individualized dental restoration structure by means of 3-D printing.

For example, the control unit can comprise a personal computer connected to the 3-D printer. Thus, the form and/or position of the substructure determined by the scanner, transmitted to a CAD program installed on the personal computer, can be compared with the 3-D data of the dental restoration structure to be individually manufactured. A volume model based thereon can be passed on to a printer control system, which is likewise part of the control unit, and a layer model for the 3-D print can be determined therefrom.

The invention also relates to the use of an in particular above-mentioned 3-D printer in an in particular above-mentioned method for producing dental restoration structures to be individually manufactured.

### BRIEF DESCRIPTION OF THE DRAWINGS

Further advantages and individual features of the invention can be gathered from the following description of an exemplary embodiment and from the drawings.

In the drawings, in schematic form:

FIG. 1 shows a flow chart of a method according to the invention for producing a dental restoration structure to be individually manufactured by 3-D printing:

FIG. 2 shows a method according to the invention for adjusting a 3-D printer;

FIG. 3 shows a 3-D printer according to the invention,.

### DETAILED DESCRIPTION OF THE PREFERRED EMBODIMENTS

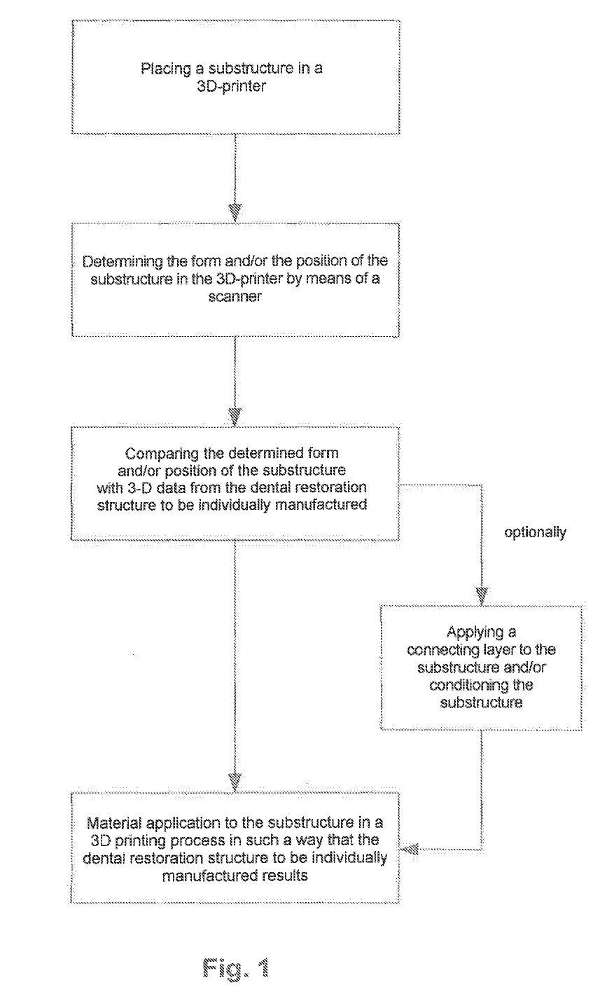

As emerges from FIG. 1, a method according to the invention for producing a dental restoration structure 1 to be individually manufactured by 3-D printing can comprise a sequence of several steps. In one embodiment, the first of these steps includes the placing of a substructure 2 in a 3-D printer 3. In the following step, the form and/or the position of the substructure 2 in the 3-D printer 3 is determined by means of a scanner 5. This is followed by a comparison of the determined form and/or the position of the substructure 2 with 3-D data of the dental restoration structure 1 to be individually manufactured. Only after the comparison has been carried out is an application of the material to the substructure 2 by means of a 3-D printing process carried out, in such a way that a dental restoration structure 1 to be individually manufactured results. Optionally, before the actual material application, the application of a connecting layer to the substructure 2 and/or conditioning of the substructure 2 can be carried out.

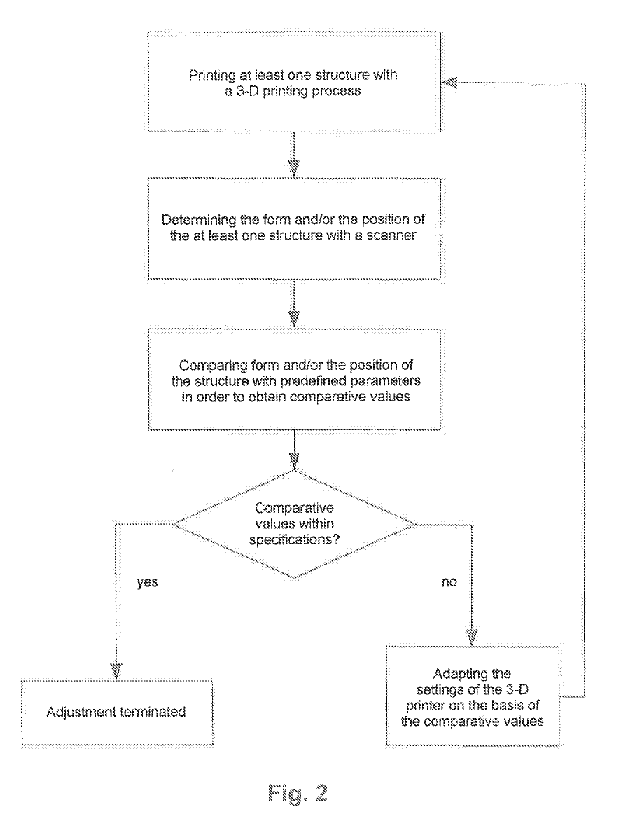

In FIG. 2, the adjustment according to the invention of a 3-D printer is illustrated. Here, the printing of at least one structure with a 3-D printing process is normally carried out as a first step of the adjustment method. Then, the form and/or the position of the at least one structure is determined by using a scanner. On the basis of the determined data, a comparison of the form and/or the position of the structure with predefined parameters is carried out in order to obtain comparative values. If these comparative values correspond to predefined specifications, further adjustment is unnecessary and the method is terminated. Should the comparative values not lie within predefined specifications, the settings of the 3-D printer are adapted, in particular on the basis of the comparative values. Preferably, the adjustment method is repeated after such an adaptation, in that a structure is again printed by a 3-D printing process.

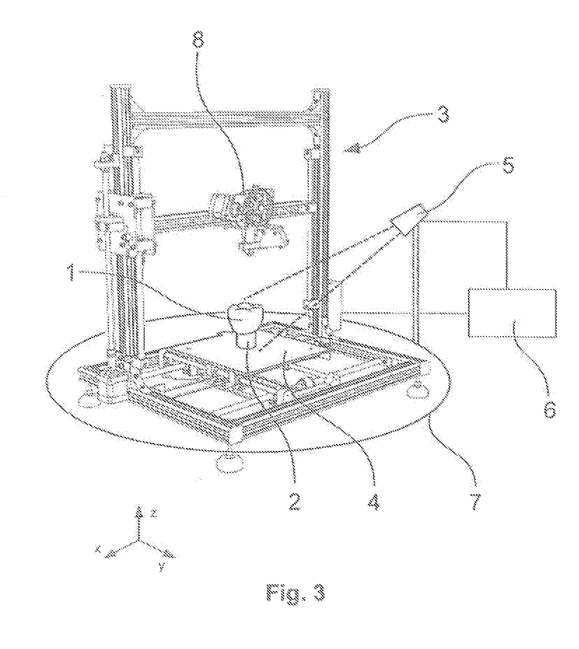

FIG. 3 shows an exemplary structure of a 3-D printer 3 according to the invention with integrated scanner 5. The scanner 5 is fitted to a circumferential rail 7, which means it is able to detect both the substrate 2 and the dental restoration structure 1 to be individually manufactured from various perspectives. The substructure 2 is fitted to a support plate 4. In the 3-D printer shown, the support plate 4 is movable in the X and Y direction, while the print head 8 is movable in the Z direction.

1-10. (canceled)

11. A method for producing a dental restoration structure to be individually manufactured by 3-D printing, the method comprising the steps:
i. placing a substructure in a 3-D printer;
ii. determining at least one of a form and a position of the substructure in the 3-D printer by a scanner; and
iii. comparing the determined at least one of the form and the position of the substructure with 3-D data from the dental restoration structure to be individually manufactured;
iv. applying material to the substructure during a 3-D printing process in such a way that the dental restoration structure to be manufactured individually results.

12. The method as claimed in claim 11, further comprising integrating the scanner of step ii in the 3-D printer.

13. The method as claimed in claim 11, further comprising applying a composite material as the material applied in step iv.

14. The method as claimed in claim 11, further comprising an additional step of at least one of:
applying a connecting layer to the substructure, and
conditioning the substructure, anterior to step iv.

15. The method as claimed in claim 11, further comprising selecting the substructure from a group consisting of dental scaffolding structures.

16. The method as claimed in claim 11, further comprising selecting the substructure from a group consisting of sub-structures for bridges or bars, abutments for implants or secondary parts; metallic or ceramic workpieces; or dental structures with ceramic crowns.

17. A method for adjusting a 3-D printer comprising the steps:
i. printing at least one structure by using a 3-D printing process;
ii. determining at least one of a form and a position of the at least one structure with a scanner;
iii. comparing the at least one of the form and the position of the structure with predefined parameters in order to obtain comparative values; and
iv. adapting settings of the 3-D printer, if necessary, on a basis of the comparative values.

18. The method for adjusting the 3-D printer as claimed in claim 17, further comprising:
v. carrying out steps i. to iv. again in order to monitor the adjustment.

19. The method for adjusting the 3-D printer as claimed in claim 17, further comprising carrying out the method for producing a dental restoration structure to be individually manufactured.

20. The method as claimed in claim 11, further comprising monitoring the 3-D printing process by using the scanner.

21. The method as claimed in claim 11, further comprising determining the form of the dental restoration structure to be individually manufactured with the scanner, and comparing with the 3-D data of the dental restoration structure to be individually manufactured provided in step iii.

22. A 3-D printer having an integrated scanner for capturing at least one of a form and a position of at least one of the substructure to be printed on and the printed object.

23. The 3-D printer as claimed in claim 22, wherein:
the scanner is for capturing at least one of the form and the position of at least one of a substructure to be printed on and a printed object; and
the 3-D printer further has a control unit, designed to carry out a method for producing a dental restoration structure comprising the steps:
i. placing a substructure in a 3-D printer;
ii. determining at least one of a form and a position of the substructure in the 3-D printer by a scanner; and
iii. comparing the determined at least one of the form and the position of the substructure with 3-D data from the dental restoration structure to be individually manufactured;
iv. applying material to the substructure during a 3-D printing process in such a way that the dental restoration structure to be manufactured individually results.

24. The 3-D printer as claimed in claim 22, wherein the scanner is designed to determine at least one of the form and the position of at least one of a substructure to be printed on and a printed object.

25. The 3-D printer as claimed in claim 22, wherein the scanner is designed to determine at least one of the form and the position of a dental restoration structure.

26. The 3-D printer as claimed in claim 23, wherein at least one of the form and the position of a substructure that can be positioned in the 3-D printer can be captured with a scanner and made available to a control unit for the additive structural creation of an individualized dental restoration structure by 3-D printing.
